(19) United States
(12) Patent Application Publication
(10) Pub. No.: US 2024/0159984 A1
(43) Pub. Date: May 16, 2024

(54) Optical cable assembly and optical cable testing method

(71) Applicant: Jiangsu SUMEC Electromechanical Co., Ltd., Nanjing (CN)

(72) Inventors: Xubo Ye, Nanjing (CN); Chao Chen, Nanjing (CN); Rong Zhou, Nanjing (CN); Renchun ZHANG, Nanjing (CN); Xuewu ZOU, Nanjing (CN); Xingwang JI; Aobo ZHU, Nanjing (CN); Cheng LI, Nanjing (CN)

(73) Assignee: Jiangsu SUMEC Electromechanical Co., Ltd., Nanjing (CN)

(21) Appl. No.: 18/197,054

(22) Filed: May 13, 2023

(30) Foreign Application Priority Data
Nov. 14, 2022 (CN) 202211427410.5

(51) Int. Cl. G02B 6/44; G01M 11/00

(52) U.S. Cl. CPC G02B 6/4457; G01M 11/33

(57) ABSTRACT

The application discloses an optical cable assembly and an optical cable testing method. The optical cable assembly comprises: an optical cable wire with a test end; a spool for winding the optical cable; a connection assembly has an optical cable connection port and a test port, the connection assembly is configured to connect objects at both ends of the connection assembly, and the test end of the optical cable is connected to the connection assembly as an object at one end of the optical cable connection port, the test port is located at an operable area of the spool, configured to connect the test equipment to form an optical path between the test equipment and the optical cable wire when the optical cable is tested.

### TECHNICAL FIELD

The present application is related to optical cable communication, in particular it is related an optical cable assembly and optical cable testing method.

### BACKGROUND

Optical cables need to be wound on a spool for storage. When leaving the factory, the inner end of the optical cable is extended a certain distance from the central axis of the spool and fixed to the side plate of the spool. At the construction site, workers need to perform attenuation and spool length tests on the entire optical cable. The specific operation process is as follows: 1. First, remove the inner end from the side plate; 2. Strip the outer sheath and loose tube of this section of the optical cable to expose the optical fiber; 3. Use alcohol and tissue to clean the grease on the optical fiber; 4. Use pliers to strip the coloring layer of the optical fiber, place it in the V-groove and perform a quick connection with the pigtail; 5. Insert the other end of the pigtail into the optical time-domain reflectometer, and obtain the attenuation and spool length information by reading the information on the optical time-domain reflectometer. The above testing scheme is cumbersome and has many disadvantages, specifically: 1. The connection of the optical fiber and pigtail through the V-groove requires strong operational experience, and the success rate for beginners is very low; 2. Pigtails are bulky and inconvenient to carry on construction sites (especially in the field); 3. Stripping optical cables is very cumbersome, especially for armored optical cables, which usually takes about an hour for two people to strip one; 4. Cleaning grease requires a large amount of tissue and alcohol, which is not environmentally friendly and time-consuming.

### SUMMARY OF THE INVENTION

The embodiments of the present application provide an optical cable assembly and an optical cable testing method, which aim to solve the technical problems of inconvenient operation, high experience requirements for operators, time-consuming, and non-environmentally friendly testing process in existing optical cable construction testing.

According to one aspect of the present invention, an optical cable assembly is disclosed. The optical cable assembly comprises an optical cable, having a test end; and a spool, configured for winding the optical cable.

A connection assembly is provided on the spool. The connection assembly has an optical cable connection port and a test port, the connection assembly is configured to connect objects at both ends of the connection assembly, and the test end of the optical cable is connected to the connection assembly as an object at one end of the optical cable connection port, the test port is located at an operable area of the spool, configured to connect the test equipment to form an optical path between the test equipment and the optical cable wire when the optical cable is being tested.

Further, the spool comprises a side plate and a winding member, the optical cable wire is wound on the winding member to form a winding area, the test port is located on one side of the side plate.

Further, the side plate is located on the inner side of the wire winding area, and the other side of the side plate is an outer side; the test port is located at the outer side of the side plate, the optical cable connection port is located on the inner side of the side plate.

Further, the optical cable connection port is located on the side plate corresponding to the outer part of the wire winding area, and the test end of the optical cable wire is led from the inner part of the wire winding area to the outer part and connected to the optical cable connection port.

Further, the winding member has a skeleton so that the optical cable wire is wound on the skeleton to form the wire winding area, and the interior of the wire winding area forms an inner cavity, and the optical cable connection port is located on the side plate corresponding to the inner cavity.

Further, the test end of the optical cable wire passes from the interior of the wire winding area into the inner cavity and is connected to the optical cable connection port.

Further, the side plates corresponding to the outer part of the wire winding area and the inner cavity, each have at least one through-holes penetrating the side plates; the test end of the optical cable wire is led from the interior of the wire winding area to the exterior, and from the through-hole on the corresponding side plate outside the wire winding area to the outer side of the side plate, then through the through-hole on the side plate corresponding to the inner cavity to the inner side of the side plate and connected to the optical cable connection port.

Further, the outer side of the side plate has a groove, and a portion of the optical cable wire located on the outer side of the side plate is placed in the groove.

Further, the connecting assembly comprises an optical fiber quick connector, configured to connect the test end of the optical cable wire to the test port.

Further, the connecting assembly further comprises a hollow flexible tube, the test end is a bare optical fiber, and the hollow flexible tube is sleeved on the exterior of the bare optical fiber and connected to the test port.

Further, the connection assembly comprises an optical fiber splitter and a hollow flexible tube, and the test end is connected to the test port after the optical fiber in the test end is threaded through the optical fiber splitter and into the hollow flexible tube.

Further, the optical fiber splitter has a protective sleeve wrapped around its input end.

Further, the optical fiber splitter is fixed to the side plate.

According to another aspect of the present invention, an optical cable testing method is disclosed herein. By using the optical cable assembly according to the first aspect of the invention, one end of the optical cable one end of the optical cable jumper is connected to the test port on the optical cable assembly, and the other end is connected to the test equipment for testing.

In the embodiments of the present application, the test end of the optical fiber is connected to the optical cable connection port of the connection assembly, and the test port on the connection assembly is exposed in an operable area for connection with the testing equipment during optical cable testing. The above structure is pre-configured on the optical cable assembly, so that at the construction site, optical cable testing can be started by simply connecting a single optical cable jumper between the test port and the testing equipment. The entire optical path construction process does not rely on experience and has the characteristics of being fast and environmentally friendly. Operators do not have direct contact with the optical cable, which solves the time-consuming and non-environmentally friendly disadvantages of existing technology that require removal and cumbersome stripping of optical cables, as well as the issues of highly experience-dependent connections between optical cables and pigtails.

### DESCRIPTION OF THE FIGURES

The drawings constituting a part of the application are used to provide further understanding of the application, and the schematic embodiments and descriptions of the application are used to explain the application, and do not constitute an improper limitation to the application. In the attached figures:

FIG. 1 is a schematic diagram of an overall structure illustration of an optical cable assembly according to an embodiment of the present application.

FIG. 2 is a schematic side view of an optical cable assembly according to an embodiment of the present application;

FIG. 3 is a schematic diagram of a side plate in an optical cable assembly according to an embodiment of the present application;

FIG. 4 is a schematic diagram of an optical cable arrangement position of an optical cable assembly according to an embodiment of the present application;

FIG. 5 is a schematic diagram of an optical cable arrangement position of an optical cable assembly according to an embodiment of the present application;

FIG. 6 is a schematic diagram of an optical cable arrangement position of an optical cable assembly according to an embodiment of the present application;

FIG. 7 is a schematic structural view of an optical fiber splitter in an optical cable assembly according to an embodiment of the present application after opening;

FIG. 8 is a schematic structural diagram of a coupler in an optical cable assembly according to an embodiment of the present application;

FIG. 9 is a schematic side view of a coupler in an optical cable assembly according to an embodiment of the present application;

FIG. 10 is a schematic structural diagram of a sink hole for installing a coupler in an optical cable assembly according to an embodiment of the present application.

In the figure, the meaning of each reference number is as follows:
Side plate 1, optical cable wire 2, sink hole 3, coupler 4, optical fiber splitter 5, groove 6, hollow tube 7, inlet hole 8-1, outlet hole 8-2, optical fiber quick connector 9, outer hole 10. Inner hole 11, upper cover 12, lower cover 13, upper fixing hole 14, lower fixing hole 15, boss 16, card seat 17, test port 18.

### DETAIL EMBODIMENTS

It should be noted that, in non-conflicting situations, the embodiments and features in the present application can be combined with each other. The present application will be described in detail with reference to the accompanying drawings and in conjunction with the embodiments.

In view of the fact that the optical cable wound on a spool in the prior art needs to be tested multiple times during the laying process, it is necessary to provide a structure and method that can achieve rapid testing, making the aforementioned testing more convenient. In the prior art, the optical cable is wound on a spool, and its test end is located at the innermost side of the coil during winding. When leaving the factory, only the test end is pulled from the inner side of the coil to the outside and fixed, so that the tester can access the test end. However, the test end itself has not been processed, and when testing is required, the tester must perform complex stripping, docking, and other work on the test end. Due to the inconvenience of the above process, the embodiments of the present invention provide an optical cable assembly in which the test end of the optical cable wound on the spool is pre-processed at the factory, leaving a port for the tester to establish an optical path between the test equipment and the optical cable to be tested. The tester can easily complete the test by directly connecting the test equipment and the port with an optical fiber communication cable, making it user-friendly.

Therefore, the structure of the optical cable assembly of the embodiments of the present application includes:

Optical cable 2, having a test end, the other end is used for laying during construction, and both ends constitute the entire optical cable 2.

A spool for winding the optical cable 2; since the end used for laying needs to be continuously taken from the spool, this end is usually exposed to the outside of the coil, while the other end is usually located on the inner side of the coil during winding. Since the other end needs to be used as a test end, it is necessary to adjust the position of the test end to facilitate the formation of an optical path between the optical fiber at the test end and the external testing equipment.

The spool has a connection assembly, which has an optical cable connection port and a test port 18. The connection assembly is used to connect the objects at both ends of the connection assembly. The test end of the optical cable 2 is connected to the connection assembly as the object at one end of the optical cable connection port, and the test port 18 is located in the operable area of the spool for connecting the test equipment during optical cable testing to form an optical path between the test equipment and the optical cable 2.

In the above structure, the test end of the optical cable is pre-connected to the connection component, and the tester does not need to operate the test end directly, but instead connects to the test equipment through the connection component, thereby establishing an optical path between the test end and the external test equipment. The connection component is exposed in the operable area for easy tester operation, and the reserved test port 18 on the connection component can be configured with an optical cable jumper with a matching connector for the test port 18. By connecting the connector of the optical cable jumper to the test port 18 and the other end of the optical cable jumper to the test equipment, the test end can be connected to the test equipment. Typically, the connection between the test equipment and the optical cable jumper is also a matching port connection. The specific connection between the optical cable jumper, test port 18, and test equipment can be achieved using standard connector products, and this type of connection is usually plug-in, screw connections, or other simple and reliable methods, making the entire process of establishing an optical path between the test port 18 and the test equipment very convenient and reliable, without relying on manual experience, and time-saving, labor-saving, and environmentally friendly with no pollution.

To facilitate the establishment of the optical path, it is better to fix the position of the test port 18 for easy operation. In some embodiments, as shown in FIG. 1, the spool includes a side panel 1 and a winding part, the optical cable 2 is wound on the winding part to form a cable winding area, and the test port 18 is located on one side of the side panel 1. The side panel 1 is usually a thin circular plate with an outer diameter larger than the winding part, and at the construction site, the side panel 1 is erected on the ground, the winding part is suspended, and the entire optical cable assembly can be easily moved by rolling the side panel 1. The area of the side panel 1 is relatively large, and an appropriate position can be selected as the fixed area for the test port 18 as needed.

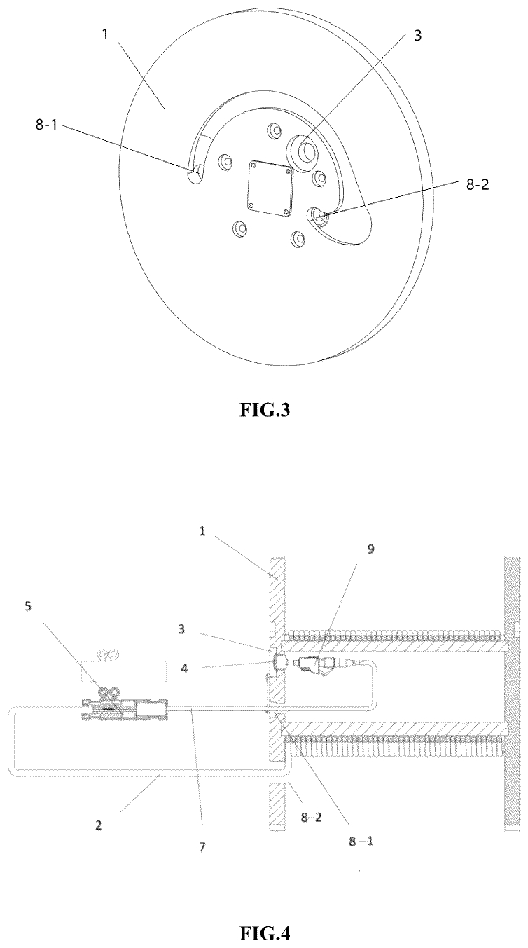

In some preferred embodiments, the inner side of the side panel 1 is located on one side of the cable winding area, and the outer side of the side panel 1 is on the other side; the test port 18 is located on the outer side of the side panel 1, and the optical cable connection port is located on the inner side of the side panel 1. Since the operable space on the outer side of the side panel 1 is larger, the test port 18 on the outer side is more convenient for the tester to operate, and the main body of the optical cable is located on the inner side of the side panel 1, so the optical cable connection port is also located on the inner side of the side panel 1 for easy connection to the test end of the optical cable. As shown in FIGS. 1 to 6, the side panel 1 has a countersunk hole 3 for installing the connection component, and the two ends of the connection component are located on the inner and outer sides of the side panel 1, with the end on the outer side of the side panel 1 being the test port 18 and the end on the inner side of the side panel 1 being the optical cable connection port.

In the above implementation examples, the position of the test end is outside the winding area, and the test end and the other parts of the optical cable 2 may affect each other during the construction of the optical cable 2. In some preferred embodiments, the winding part has a frame so that the optical cable 2 is wound on the frame to form the cable winding area, and an inner cavity is formed inside the cable winding area, with the optical cable connection port located on the side panel 1 corresponding to the inner cavity. As shown in FIGS. 1-4 and 6, in some embodiments, the frame is a tubular structure with an inner cavity, and in other embodiments, the frame consists of multiple rods parallel to the same cylindrical axis, each approximately located on the outer peripheral surface of the cylinder, and the interior is also an inner cavity. By moving the position of the optical cable connection port to the corresponding area of the inner cavity, the test end also needs to be moved to the corresponding position, accordingly, thus avoiding mutual interference with the optical cables at other positions of the optical cable 2 and being less susceptible to damage from external forces.

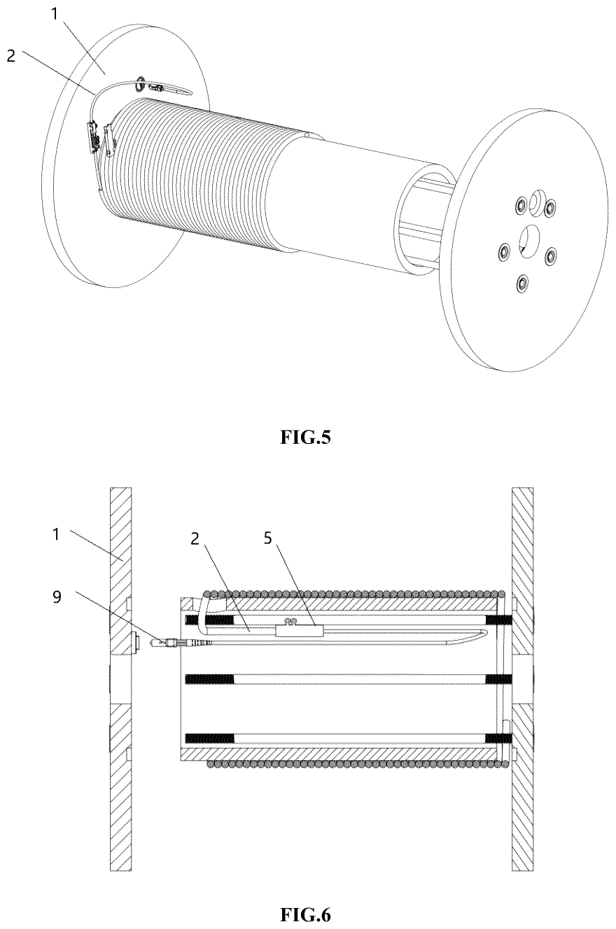

In some preferred embodiments, since the optical cable 2 is wound on the outside of the frame, the test end of the optical cable 2 passes from the inside of the cable winding area to the inner cavity and connects to the optical cable connection port. As shown in FIG. 6, for a tubular core frame structure, the test end can be introduced into the inner cavity by drilling holes in the side wall of the tube. Similarly, for a rod-shaped frame, the test end can be directly introduced into the inner cavity through the gaps between the rods. Since there is usually only a small hole between the inner cavity and the external operable area, the test end of the above structure is hardly affected by external construction, effectively ensuring the stability of the test end connection.

In other embodiments, the test end can also be moved to the position of the optical cable connection port as shown in FIG. 1. As shown in FIGS. 1 to 4, the outer side of the cable winding area and the side panel 1 corresponding to the inner cavity each have at least one through-hole penetrating the side panel 1, with one through-hole being an inlet hole 8-1 and the other through-hole being an outlet hole 8-2. The test end of the optical cable 2 is led from the inside of the cable winding area to the outside of the cable winding area and from the outside of the cable winding area to the side panel 1 corresponding to the through-hole, i.e., the outlet hole 8-2, penetrating the side panel 1 to the outer side. Then, the test end passes through the through-hole on the side panel 1 corresponding to the inner cavity, i.e., the inlet hole 8-1, to the inner side of the side panel 1 and connects to the optical cable connection port.

In the above embodiments, to accommodate the optical cable 2 on the outer side of the side panel 1, the outer side of the side panel 1 has a groove 6, and the part of the optical cable 2 on the outer side of the side panel 1 is placed in the groove 6. In some preferred embodiments, the groove 6 can also be equipped with a cover component to form a shield for the objects inside the groove 6, providing protection for the optical cable 2 inside the groove 6 on one hand, and making the outer side of the side panel 1 more even on the other hand.

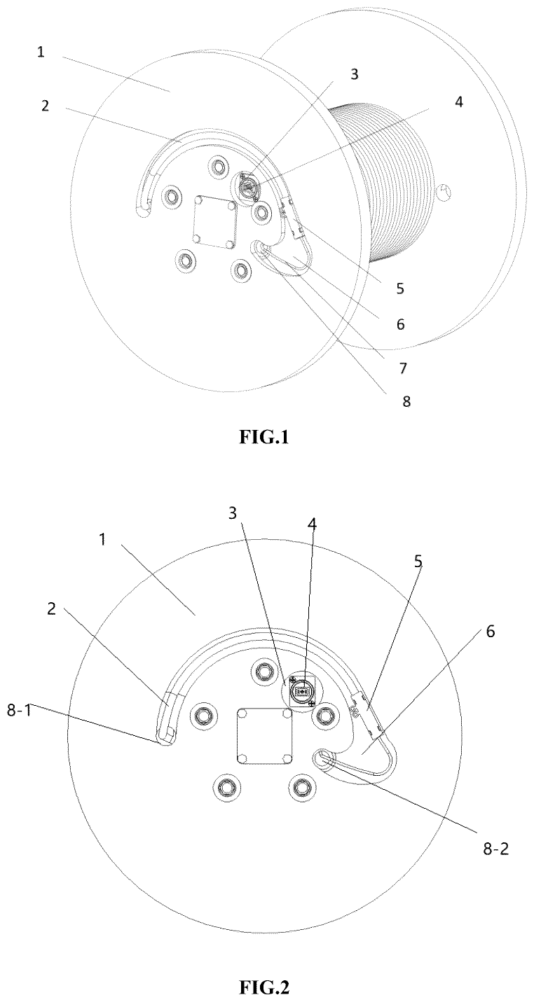

Based on the above embodiments, there are also some preferred implementation methods for the connection between the test end and the connection component. Referring to FIGS. 2, 4, 5, and 6, in order to more reliably connect the test end and the connection component, the connection component includes not only two ports but also an optical fiber quick connector 9. The optical fiber quick connector 9 is used for connecting the test end of the optical cable 2 with the test port 18, achieving a fast and effective connection between the test end and the test port 18.

Since the general optical cable 2 is not easy to bend, to smoothly connect the test end to the test port 18, a softer optical cable 2 is needed. Therefore, in some preferred embodiments, a hollow flexible tube 7 is provided for the connection component. The test end is an exposed optical fiber, as shown in FIGS. 1-2 and 4-6. The hollow flexible tube 7 is sleeved on the outside of the exposed optical fiber to become more easily bendable, and the hollow flexible tube 7 can also replace the original fiber protective sleeve to protect the optical fiber, thus facilitating the connection of the test end to the test port 18. The flexible end of the hollow tube can be quickly connected to the test port 18 with the optical fiber quick connector 9 mentioned in the above embodiments.

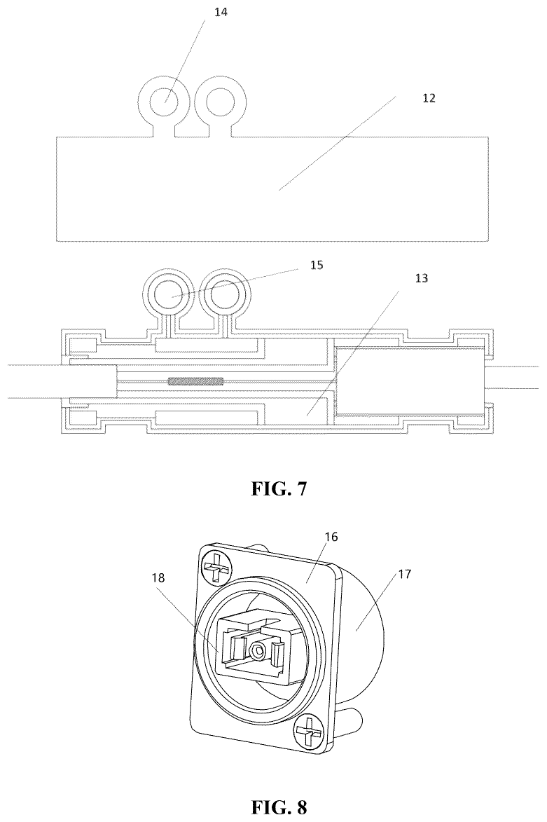

In the above embodiments, the fiber tail of the test end is still in the original protective sleeve, i.e., part of the optical fiber is sleeved into the hollow flexible tube 7, and the other part remains in the original protective sleeve. In this case, there must be more or less exposed optical fiber between the original protective sleeve and the hollow flexible tube 7. Therefore, in some preferred embodiments, considering the bending requirements and sufficient protection of the optical cable 2, these embodiments also include an optical fiber splitter 5. The structure of the optical fiber splitter 5 is shown in FIG. 7, which includes an upper cover 12 and a lower cover 13, with an upper fixing hole 14 on the upper cover 12 and a lower fixing hole 15 on the lower cover 13. The upper cover 12 and the lower cover 13 are detachable. When the upper cover 12 and the lower cover 13 are closed together, a cavity is formed, and the upper fixing hole 14 and the lower fixing hole 15 are aligned with each other. The inlet end of the optical fiber splitter 5 is connected to the end of the original protective sleeve, i.e., the thicker conduit on the left side of FIG. 7, and the outlet end of the optical fiber splitter 5 is connected to the hollow flexible tube 7, i.e., the thinner conduit on the right side of the figure. The optical fiber can extend from the original protective sleeve through the inner cavity of the optical fiber splitter 5 into the hollow flexible tube 7 and finally connect to the test port 18 along with the hollow flexible tube 7. In this way, the exposed part of the optical fiber between the original protective sleeve and the hollow flexible tube 7, which may be more or less present, is located inside the optical fiber splitter 5, and the optical fiber splitter 5 provides protection for this part of the optical fiber. Thus, the protection of the optical fiber is achieved by using the optical fiber splitter 5 in combination with the hollow flexible tube 7, replacing the original protective sleeve.

Since the stability of the optical fiber splitter 5 as a protective component for the optical fiber is very important, in some preferred embodiments, protective sleeves are wrapped around the inlet and/or outlet ends of the optical fiber splitter 5 to keep the relative positions between the optical fiber splitter 5, the original protective sleeve, and/or the hollow flexible tube unchanged. In some embodiments, as shown in FIGS. 1 and 2, the optical fiber splitter 5 itself is fixed relative to the side panel 1, and the upper fixing hole 14 and lower fixing hole 15 on the optical fiber splitter 5 can be fixed to the side panel 1 using fasteners such as screws, thus achieving the fixation of the optical fiber splitter 5 and enabling it to better protect the internal optical fiber.

The various features involved in the above embodiments can be designed according to requirements or standard parts can be used. Now, with reference to FIGS. 1 to 4, specific parameters of the various components in this embodiment are provided.

The side panel 1 is made of plywood or solid wood material, with a countersunk hole on the outer side, as shown in FIG. 10, including an outer hole 10 on the outer side of the side panel 1 and an inner hole 11 on the inner side of the side panel 1. The outer hole 10 has a larger diameter, while the inner hole 11 has a smaller diameter, and the two are concentrically combined to form a stepped through hole. The outer side of the side panel 1 also has a groove 6 for accommodating the optical cable 2 and the splitter, with the depth of the groove 6 being approximately 10-15 mm. The groove 6 at the optical fiber splitter 5 is a circular groove with a diameter of approximately 80 mm.

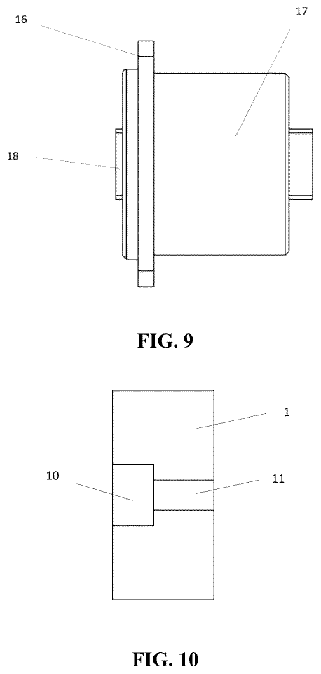

The connector component uses a coupler 4 to provide the optical cable connection port and the test port 18. As shown in FIGS. 8 and 9, the optical cable connection port and the test port 18 both use female quick connectors (which can be common models such as LS, SC, or FC). In addition to the aforementioned optical cable connection port and test port 18, the coupler 4 also has a socket 17 for installing the two ports. The socket 17 has a cylindrical base and a square raised platform 16 with an outer diameter larger than the cylindrical base. The socket 17 is installed into the countersunk hole from the outer hole 10 side, with the raised platform 16 abutting the step of the countersunk hole and fixed with self-tapping screws, thereby achieving the purpose of fixing the coupler 4 to the side panel 1.

The length of the optical cable extending from the inside to the outside of the side panel 1 is approximately 0.5 m-2 m. The protective sleeve outside the optical fiber splitter 5 uses heat-shrink tubing. The optical cable on the outer side of the side panel 1 and the optical fiber splitter 5 are both located in the groove 6 on the side panel 1, and the optical fiber splitter 5 is fixed in the groove 6. The hollow flexible tube 7 for protecting the optical fiber has a diameter of 0.6-2.0 mm, and the material is generally a highly flexible polymer material such as TPEE, LSZH, PA, or PVC. The optical fiber quick connector 9 and the end of the optical cable jumper connected to the test port 18 during testing are both male connectors, and the two male connectors are evenly adapted to the female connectors on the coupler 4.

The embodiments of the present invention also disclose the optical cable testing method of the optical cable assembly of the aforementioned embodiments, which specifically includes:

There is no need to remove the test end and strip its outer protective sleeve and loose tube to expose the optical fiber, nor is there a need to wipe the grease on the surface of the optical fiber clean and quickly connect the tail fiber after the glass coloring layer.

Instead, the optical cable jumper is directly connected to the test port 18 on the optical cable assembly at one end and to the testing equipment at the other end to perform the test and obtain the relevant information of the tested optical cable. The testing equipment is generally an Optical Time Domain Reflectometer (OTDR), which can obtain information such as fiber length or attenuation.

The entire process of establishing the optical path is fast, and compared to the original method, which required several hours of work, the solution in this embodiment can be completed in a matter of seconds, greatly improving the work efficiency of on-site testing personnel.

The above are only embodiments of this application and are not intended to limit this application. For those skilled in the art, this application can have various modifications and variations. Any modification, equivalent substitution, improvement, etc., made within the spirit and principle of this application, should be included within the scope of the claims of this application.

1. An optical cable assembly, comprising:
an optical cable, having a test end;
a spool, configured for winding the optical cable;
a connection assembly, on the spool,
wherein the connection assembly has an optical cable connection port and a test port, the connection assembly is configured to connect objects at both ends of the connection assembly,
and the test end of the optical cable is connected to the connection assembly as an object at one end of the optical cable connection port, the test port is located at an operable area of the spool, configured to connect the test equipment to form an optical path between the test equipment and the optical cable wire when the optical cable is being tested.

2. The optical cable assembly according to claim 1, wherein the spool comprises a side plate and a winding member, the optical cable wire is wound on the winding member to form a winding area, the test port is located on one side of the side plate.

3. The optical cable assembly according to claim 2, wherein the side plate is located on the inner side of the wire winding area, and the other side of the side plate is an outer side; the test port is located at the outer side of the side plate, the optical cable connection port is located on the inner side of the side plate.

4. The optical cable assembly according to claim 3, wherein the optical cable connection port is located on the side plate corresponding to the outer part of the wire winding area, and the test end of the optical cable wire is led from the inner part of the wire winding area to the outer part and connected to the optical cable connection port.

5. The optical cable assembly according to claim 3, wherein the winding member has a skeleton so that the optical cable wire is wound on the skeleton to form the wire winding area, and the interior of the wire winding area forms an inner cavity, and the optical cable connection port is located on the side plate corresponding to the inner cavity.

6. The optical cable assembly according to claim 5, characterized in that the test end of the optical cable wire passes from the interior of the wire winding area into the inner cavity and is connected to the optical cable connection port.

7. The optical cable assembly according to claim 5, characterized in that the side plates corresponding to the outer part of the wire winding area and the inner cavity, each have at least one through-hole penetrating the side plate; the test end of the optical cable wire is led from the interior of the wire winding area to the exterior, and from the through-hole on the corresponding side plate outside the wire winding area to the outer side of the side plate, then through the through-hole on the side plate corresponding to the inner cavity to the inner side of the side plate and connected to the optical cable connection port.

8. The optical cable assembly according to claim 7, characterized in that the outer side of the side plate has a groove, and a portion of the optical cable wire located on the outer side of the side plate is placed in the groove.

9. The optical cable assembly according to claim 1, characterized in that the connecting assembly comprises an optical fiber quick connector, configured to connect the test end of the optical cable wire to the test port.

10. The optical cable assembly according to claim 9, characterized in that the connecting assembly further comprises a hollow flexible tube, the test end is a bare optical fiber, and the hollow flexible tube is sleeved on the exterior of the bare optical fiber and connected to the test port.

11. The optical cable assembly according to claim 9, characterized in that the connection assembly comprises an optical fiber splitter and a hollow flexible tube, and the test end is connected to the test port after the optical fiber in the test end is threaded through the optical fiber splitter and into the hollow flexible tube.

12. The optical cable assembly according to claim 11, characterized in that the optical fiber splitter has a protective sleeve wrapped around its input end.

13. The optical cable assembly according to claim 11, characterized in that the optical fiber splitter is fixed to the side plate.

14. An optical cable testing method using the optical cable assembly according to claim 1, characterized in that one end of the optical cable jumper is connected to the test port on the optical cable assembly, and the other end is connected to the test equipment for testing.
